(19) United States
(12) Patent Application Publication
(10) Pub. No.: US 2001/0029969 A1
(43) Pub. Date: Oct. 18, 2001

(54) Cleaning jig for cleaning lubrication system of an automobile engine

(76) Inventor: Kazuki Yukumoto, Okayama-ken (JP)

Correspondence Address: YOUNG & THOMPSON, 745 SOUTH 23RD STREET 2ND FLOOR, ARLINGTON, VA, 22202

(21) Appl. No.: 09/885,989

(22) Filed: Jun. 21, 2001

Related U.S. Application Data
(62) Division of application No. 09/427,276, filed on Oct. 26, 1999.

(30) Foreign Application Priority Data
Apr. 2, 1999 (JP) 96387/1999

(51) Int. Cl. B08B 9/00

(52) U.S. Cl. 134/22.18; 134/34; 134/169 A

(57) ABSTRACT

Since a static cleaning process is practiced when an engine is at rest, no rotation is imparted to a camshaft 15, a connecting rod 16, a crankshaft 17, a valve lifter 18, and the like. This means that no cleaning oil is splashed over the entire peripheral surfaces of the above components, resulting in incomplete cleaning.

In addition, since an engine oil pump 24 is not rotated as well, cleaning is impossible because no cleaning oil is permitted to flow into a lower lubrication system as well as an oil cooler and a turbocharger. The lower lubrication system is readily clogged with dirt. Both of the oil cooler and the turbocharger are disposed in currently available engines.

A dynamic cleaning process for cleaning a running engine provides a substantially high level of cleaning effectiveness.

In addition, an oil injection block is constructed so as to be brought into snug engagement with an oil injection hole at one-touch control.

### BACKGROUND OF THE INVENTION

1. Field of the Invention

This invention relates to a method for cleaning a lubrication system of an automobile engine in order to realize improved performance efficiency of the engine as well as a prolonged service life thereof, and further relates to a structure of a cleaning jig for practicing the cleaning method.

2. Description of the Related Art

When a gasoline engine-operated vehicle as well as a diesel engine-powered vehicle are run for a substantially long period of time, what is called sludge caused by oil burning, impurities, worn metallic particles, etc. is deposited inside the engine. The sludge contributes to degradation in engine performance, such as reduced engine output, aggravated fuel efficiency, loud engine noise, increased engine vibration, and carbonaceous dark smoke developed in exhaust gases.

In recent years, there has been a desire, particularly in public life, to improve such aggravated engine performance by way of a countermeasure to realize fuel economy, which contributes to savings in petroleum resources, and a further countermeasure to alleviate an earth warmth phenomenon that is influenced by CO2, NOX, etc. in the exhaust gases.

To this end, past practice is to effect overhaul in which the engine is taken apart for cleaning. However, it requires considerable cost and time. Therefore, there has been a continuing demand for a simpler method.

The recent trend is to employ a static cleaning process. This is a method for cleaning a lubrication system of an engine using a cleaning machine in a state of the engine remaining stationary.

This method requires no engine teardown, and is in widespread use because of convenience of use, low cost, and cleaning in a short time.

FIG. 10 illustrates an appearance of one example of a conventional static cleaning process, in which the cleaning machine is used in a state of the engine being deactivated in a gasoline-powered vehicle. An engine body 1 is connected to a cleaning machine 2 through hoses and the like. FIG. 11 is a systematic illustration, showing a cleaning method with reference to a cross-section of the conventional static cleaning process.

In FIG. 11, a drain hose 5 extending from a drain hole 3 of the engine body 1 through a drain block 4 is communicated to a drainpipe 6 of the cleaning machine 2. The drainpipe 6 is joined to a drain pump 7, and cleaning oil is thereby drawn into the drainpipe 6. The drain pump 7 is actuated to remove sludge or metallic particles from the cleaning oil through a filter 8. Such filtered oil is then discharged into a solvent tank 9.

In the solvent tank 9, cleaning oil in amounts necessary for cleaning is reserved in advance. A discharge pump 10 supplies the cleaning oil from the solvent tank 9 to an upper lubrication passage 14 inside of the engine through an inject pipe 11 and then through a filter block 13. The filter block 13 is joined to an oil filter hole 12. The cleaning oil flowing through the upper lubrication passage 14 is dropped onto engine components required for lubrication, such as a camshaft 15, a connecting rod 16, a crankshaft 17, a valve lifter 18, and so on. The cleaning oil flowing down from the above-mentioned engine components is collected and held in an oil pan 19. The collected cleaning oil is then fed to the drainpipe 6 through the aforesaid drain hole 3, thereby forming a circulating path.

Since the static cleaning process is executed when the engine is shut down, the cleaning oil washes an inner wall of the upper lubrication passage 14 as well as parts of respective upper surfaces of the stationary camshaft 15, connecting rod 16, crankshaft 17, valve lifter 18, and so on. More specifically, the cleaning oil dropping onto such components 15, 16, 17, and 18 is caused to stream down through only parts of the upper surfaces thereof.

Since the engine remains stopped, no rotation is imparted to the camshaft 15, the connecting rod 16, the crankshaft 17, the valve lifter 18, etc. Fundamentally, centrifugal forces caused by rotary motions of such components sprinkle cleaning oil, thereby providing a cleaning effectiveness. In the static cleaning process, however, the cleaning oil is caused to merely flow down in partial contact with the above stationary components. More specifically, the cleaning oil is not applied to the entire peripheral surfaces of the above components 15, 16, 17, and 18, resulting in incomplete cleaning.

In addition, in the static cleaning process, the stationary engine locks against rotation of the engine oil pump 24. As a result, cleaning is impossible because no cleaning oil is permitted to flow into engine parts that are easily clogged with dirt, such as a passage between a strainer 23 and the engine oil pump 24, the inside of an engine pump 21, the inside of a bearing, and the lower lubrication passage 23, and further because no cleaning oil is drawn into an oil cooler as well as a turbocharger. The oil cooler and the turbocharger are both mounted in currently available engines.

Another drawback is that engine components assume ambient temperatures when the engine is at rest, and the cleaning oil cannot exercise cleaning effectiveness that increases with a rise in temperature.

### SUMMARY OF THE INVENTION

In order to provide an extremely high level of engine cleaning, which is never reached by the above-described static cleaning process, an object of the present invention is to provide an innovative method (hereinafter called a dynamic cleaning process) for cleaning a running engine, in short, for realizing dynamic cleaning.

To this end, the present invention provide a method for cleaning a lubrication system of an engine, comprising the steps of: supplying cleaning oil stored in a solvent tank of a cleaning machine to an upper portion of an engine chamber through an oil injection hole of the engine by means of a discharge pump, at which time, the engine is running, and such injected cleaning oil is thereby splashed over the entire inner surface of the engine chamber by means of a camshaft, a connecting rod, a crankshaft, a valve lifter, and so on, all of which are rotating, the cleaning oil being thereafter caused to stream down into an oil pan; permitting the cleaning oil reserved in the oil pan to flow into a lower lubrication passage through a strainer by means of an engine oil pump; then supplying the cleaning oil to an upper lubrication passage through an injection passageway of an oil filter block, the oil filter block being joined to an oil filter hole; permitting the cleaning oil to be again scattered over the entire inner surface of the engine chamber by means of the revolving camshaft, connecting rod, crankshaft, valve lifter, etc., the cleaning oil streaming down therefrom being stored in the oil pan; permitting the cleaning oil to be drawn from the oil pan into the cleaning machine through a drainpipe by means of a drain pump in the cleaning machine, a drain hole of the oil pan being connected to the drain pump through the drainpipe; discharging the cleaning oil into the solvent tank through a filter, thereby forming a circulating path; stopping the engine when a cleaning process is completed in which the engine is run in the above-described state for nearly 10˜60 minutes and the most preferably for some 30 minutes; and, then supplying air from a source of air, thereby air-purging the cleaning oil that is adhered to cleaned portions inside the engine. Further, the present invention provides a cleaning jig or oil injection block for cleaning a lubrication system of an engine, the improvement wherein the oil injection block is constructed so as to be merely inserted with pressure into an oil injection hole, thereby connecting cleaning routes together.

### BRIEF DESCRIPTION OF THE DRAWINGS

FIG. 1 is an illustration, showing an appearance of a dynamic cleaning process;

FIG. 2 is a systematic illustration, showing a cleaning method with reference to a cross-section of the dynamic cleaning process;

FIG. 3 is a systematic illustration, showing a cleaning method with reference to a cross-section of the dynamic cleaning process in a vehicle having an oil cooler and a turbocharger disposed therein;

FIG. 4 is a systematic illustration, showing a cleaning method according to a second embodiment with reference to a cross-section of the dynamic cleaning process;

FIG. 5 is a cross-sectional view, illustrating a filter block;

FIG. 6 is a plan view, illustrating the filter block;

FIG. 7 is a perspective view, showing an oil injection block;

FIG. 8 is a cross-sectional view, illustrating the oil injection block;

FIG. 9 is a plan view, showing the oil injection block;

FIG. 10 is an illustration, showing an appearance of a conventional process; and,

FIG. 11 is an illustration, showing a cleaning method with reference to a cross-section of the conventional process.

### DESCRIPTION OF THE PREFERRED EMBODIMENTS

Embodiments of the present invention will now be described with reference to the drawings.

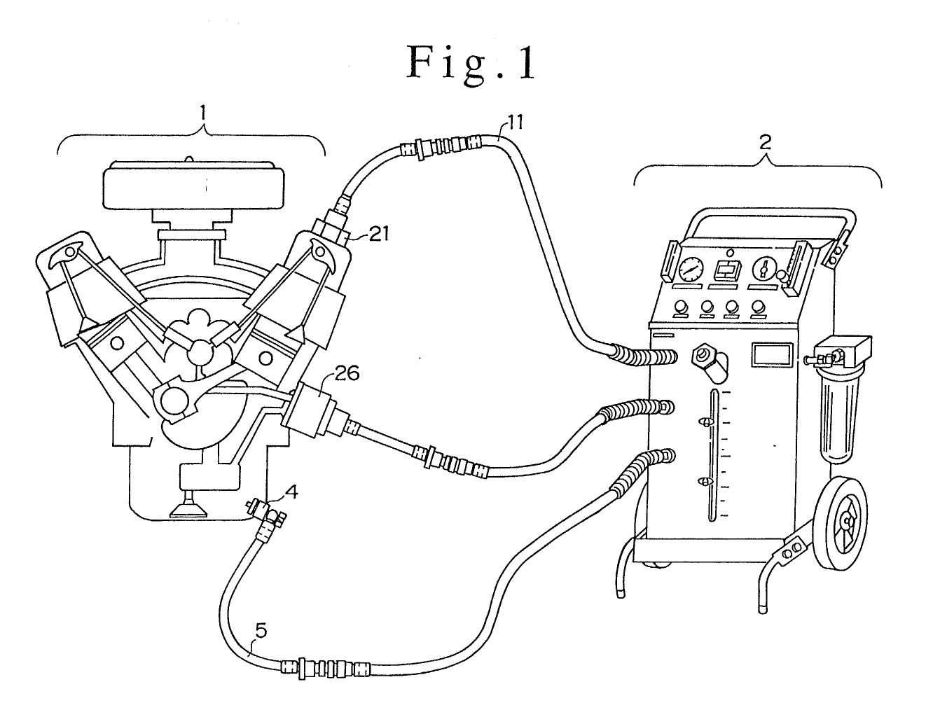

FIG. 1 is an illustration, showing an appearance of a dynamic cleaning process according to a first embodiment, in which a cleaning machine is used in a state of an engine being operated in a gasoline-powered vehicle.

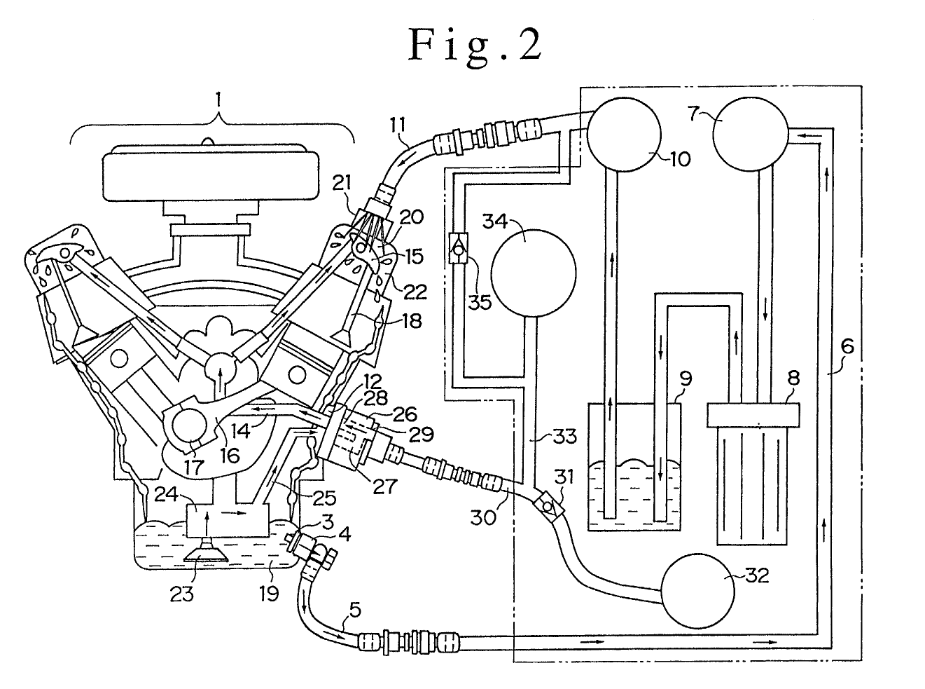

An engine body 1 is connected to a cleaning machine 2 through hoses or pipes. FIG. 2 is a systematic illustration, showing a cleaning method with reference to a cross-section of the dynamic cleaning process.

As illustrated in FIG. 2, the cleaning machine 2 usually includes a drainpipe 6, a drain pump 7, a filter 8, a solvent tank 9, a discharge pump 10, a connection pipe 30, check valves 31 and 35, a source of air 32, a branch pipe 33, a pressure meter 34, and so on. The cleaning machine 2, however, may freely be formed by any combination of the above components.

A drain hose 5 extending from a drain hole 3 of the engine body 1 through a drain block 4 is connected to the drainpipe 6. The drainpipe 6 is joined to the drain pump 7, and cleaning oil is thereby drawn into the drainpipe 6. The drain pump 7 is actuated to remove sludge or metallic particles from the cleaning oil through a filter 8. Such filtered oil is then discharged into the solvent tank 9.

In the solvent tank 9, the cleaning oil in amounts required for cleaning is stored in advance. The discharge pump 10 supplies the cleaning oil to an upper portion of an engine chamber 22 through an injection pipe 11 and then through an oil injection block 21. The oil injection block 21 is joined to an oil injection hole 20.

At this time, different from conventional static cleaning processes, the cleaning oil is fed into the running engine. Therefore, a camshaft 15, a connecting rod 16, a crankshaft 17, a valve lifter 18, and so on are rotating in union with engine operation.

As a result, the cleaning oil injected through the oil injection hole 20 is sprinkled over the entire inner surface of the engine chamber 22 by means of the above components 15, 16, 17, and 18 at the number of idle rotation during engine idle operation. When an engine rotational speed is increased, the cleaning oil is splashed over the entire inner surface of the engine chamber 22 by the aforesaid components at the increased number of rotation. Thus, a cleaning effectiveness associated with a running state of the engine is achievable.

Turning now to the cleaning oil stored in the oil pan 19, since the engine is operated, an engine oil pump 24 permits the cleaning oil to flow from the oil pan 19 into a lower lubrication passage 25 through a strainer 23. The cleaning oil is then fed into a supply passage 28 and a connection passage 29 through an injection passageway 27 of an oil filter block 26. The oil filter block 26 is joined to an oil filter hole 12.

The cleaning oil poured into the supply passage 28 is then supplied to an upper lubrication passage 14. The cleaning oil flowing through the passage 14 is dropped onto the camshaft 15, a connecting rod 16, a crankshaft 17, a valve lifter 18, and so on. At this time, the engine is running. Thus, the cleaning oil is scattered over respective upper portions of the rotating camshaft 15, connecting rod 16, crankshaft 17, valve lifter 18, etc. Consequently, the entire peripheral surfaces of the above components are wet with the cleaning oil. Then, centrifugal forces caused by rotary motions of such components sprinkle the cleaning oil over the entire inner surface of the engine chamber 22, and the cleaning oil is thereby applied thereto. The cleaning oil flowing down from the inner surface of the engine chamber is collected and held in the oil pan 19. The collected cleaning oil is fed to the cleaning machine 2 through the aforesaid drain hole 3, thereby forming a circulating path.

The connection pipe 30, which is joined to the connection passage 29 through the injection passageway 27 of the oil filter block 26, is branched into two branch pipes along two directions, one of which branch pipes is connected to the source of air 32 through the check valve 31.

The other branch pipe 33 has the pressure meter 34 mounted thereon. The branch pipe 33 is communicated to the injection pipe 11 through the check valve 35.

The cleaning oil flowing into the branch pipe 33 is blocked from flowing through the branch pipe 33 by means of the check valves 31 and 35. At this time, the pressure meter 34 indicates the pressure of discharge from the engine oil pump 24. Thus, it is possible to monitor the engine oil pump 24 for abnormal operation. It is also possible to detect a loss of pressure inside lubrication system piping, and further to check how effectively cleaning is accomplished because sludge inside the engine is removed therefrom in response to extensive cleaning, and further because a loss of pressure decreases with an increase in cleaning effectiveness.

When the pressure of the cleaning oil inside the branch pipe 33 drops below the discharge pressure of the supply pump 10, then the check valve 35 is opened. Then, the supply pump 10 allows the additional cleaning oil to be supplied to the upper lubrication passage 14 in order to protect the engine.

In the above state, a cleaning process in which the engine is run for some 10˜60 minutes is practiced. In particular, for this cleaning process, it is desirable to operate the engine for about half an hour. When the cleaning process is completed, then air is supplied from the source of air 32, thereby air-purging the cleaning oil adhered to cleaned areas inside the engine. This process is essential for complete removal of the cleaning oil because the cleaning oil is contaminated with removed sludge or metallic particles after cleaning, and further because the lubricating oil contaminated with the cleaning oil is turned to asphalt-like fluid that extremely adversely affects the engine.

In the above-described dynamic cleaning process in which the running engine is cleaned, the cleaning oil assumes a temperature as high as nearly 100˜70° C.

This means that the dynamic cleaning process provides a substantially high degree of the cleaning effectiveness of the cleaning oil, as compared with cleaning effectiveness at atmospheric temperature in the static cleaning process.

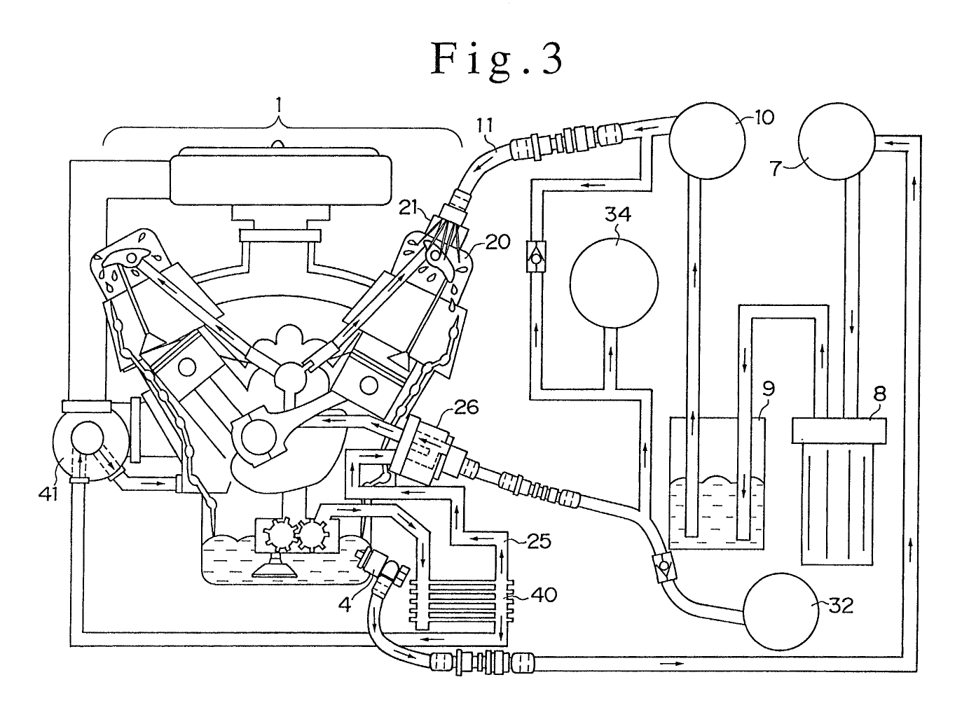

FIG. 3 is a systematic illustration, showing the same cleaning method applied to a gasoline-powered vehicle that has an oil cooler 40 and a turbocharger 41 disposed therein.

Although the present embodiment has been described with reference to the gasoline engine-operated vehicle, a cleaning method similar to the above is applicable to diesel engine-operated vehicles, only except for kinds of the cleaning oil.

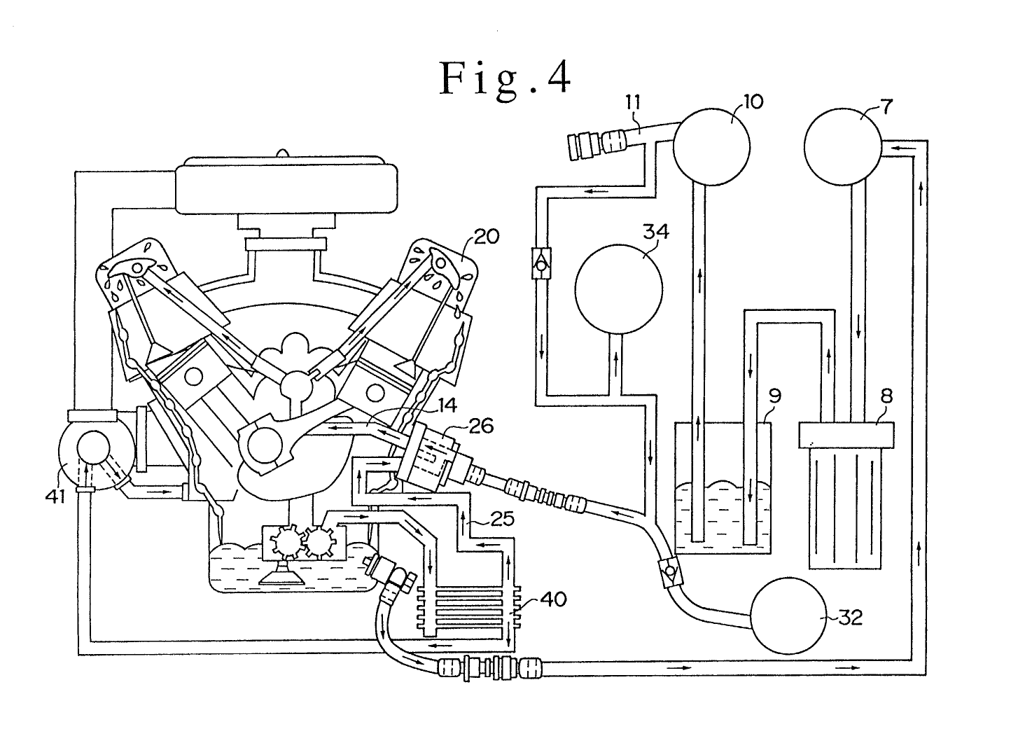

FIG. 4 illustrates a second embodiment of a dynamic cleaning process, as defined in claim 2.

More specifically, in the second embodiment, an injection pipe 11 is shown unconnected to an oil injection hole 20, but cleaning oil discharged by a supply pump 10 is fed into an oil filter hole through a filter block 13, and is then supplied to a lubrication path 14.

In the second embodiment of FIG. 4, the dynamic cleaning process can be practiced in a similar manner, and thus provides the same effectiveness.

Pursuant to this cleaning method, although a connecting pipe is easily connectable, there is a likelihood that the engine is damaged because no cleaning oil flows in the lubrication path 14 in case a supply pump 10 and/or a drain pump 7 are out of order. Accordingly, the embodiment of FIGS. 1˜3 is superior to the second embodiment from the viewpoint of safety.

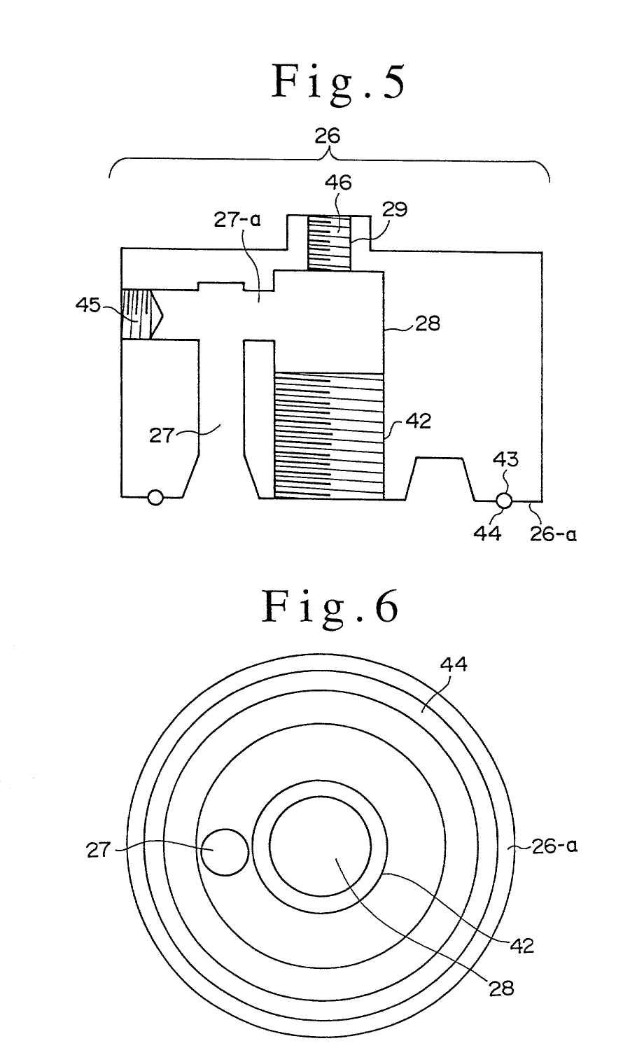

Next, a jig or filter block 26 for practicing the cleaning method according the present invention will be described. FIG. 5 shows one example of a detailed structure of the filter block 26.

A fixing screw thread 42, which is provided at one end of a supply passage 28, matches in size with any filter element replacement screw specified by engines. An oil filter is removed from the screw thread 42, and instead the filter block 26 is threadingly engaged with the screw thread 42.

A joint side 26-a of the filter block 26 is provided with an O-ring groove 43. In addition, an O-ring 44 is fitted in the groove 43. As a consequence, the O-ring groove 43 and O-ring 44 allow the filter block 26 to be jointed tightly to the engine body when the filter block 26 is threadingly engaged with the screw thread 42.

As illustrated in FIGS. 5 and 6, an inflow passage 27 is provided parallel to the supply passage 28. As shown in FIG. 2, the inflow passage 27 is communicated at one end to a lower lubrication passage 25 inside the engine. The opposite end of the inflow passage 27 is communicated to the supply passage 28 through one end of a perpendicular portion 27-a. A plug 45 closes the other end of the perpendicular portion 27-a.

A connection passage 29 is provided at the opposite end of the supply passage 28 so as to be connected to a connection pipe 30 by means of a connection screw thread 46. The connection screw thread 46 is provided in the connection passage 29.

The aforementioned filter block 26 is arranged to readily establish a route through an oil filter-mounting portion in a short time when the filter block 26 is disposed in position.

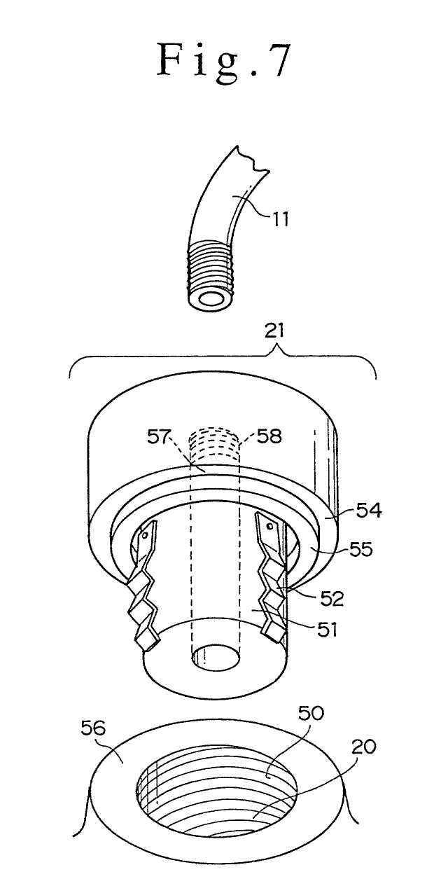

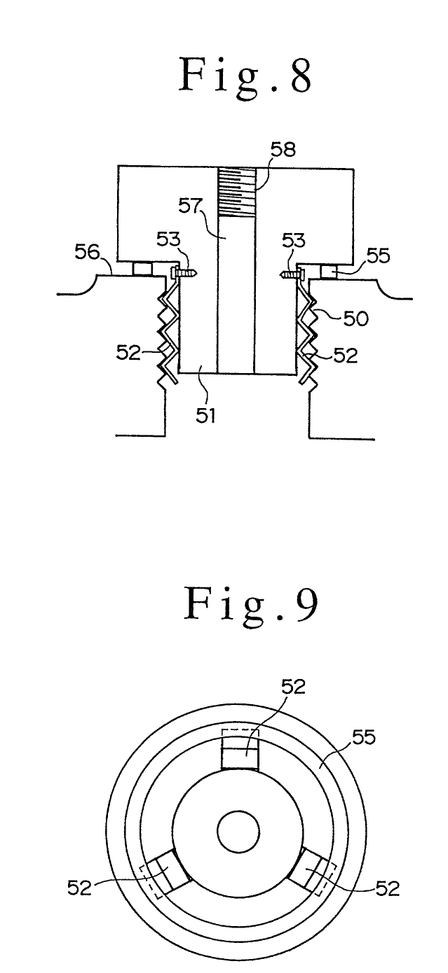

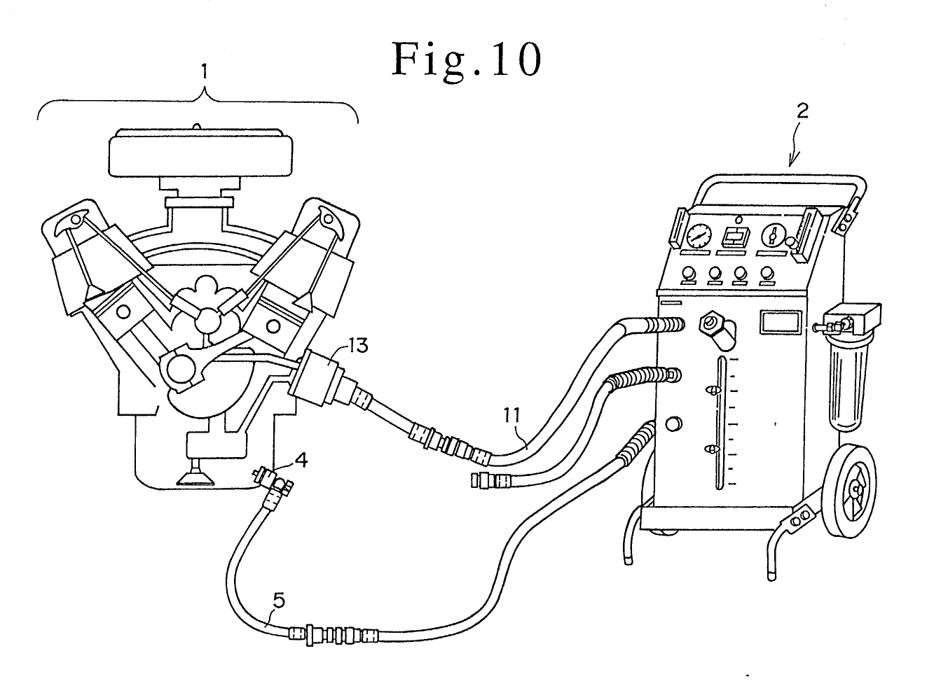

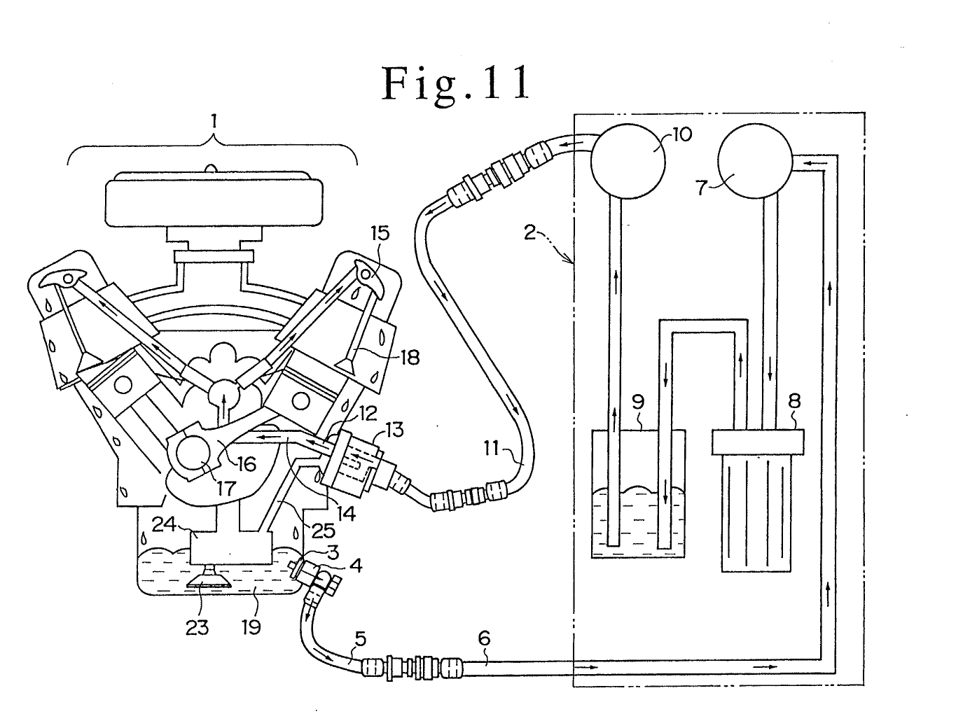

FIGS. 7, 8, and 9 illustrate one example of a structure of an oil injection block 21. The oil injection block 21 is joined to an oil injection hole 20.

In FIG. 7, a cap-mounting screw thread 50 is provided in an inner surface of the oil injection hole 20. A diameter of the screw thread 50 varies from engine to engine. In order to provide the screw thread 50 common to all engines, a jig or oil injection block having a diameter complying with that of the screw thread 50 must be fabricated, which results in consumption of time and labor. In particular, for customers who are too busy to spare much time for cleaning, there are cases where it takes too long time to provide such a jig, thereby precluding cleaning work from being practiced.

In the structure of the oil injection block 21 pursuant to the present invention as shown in FIGS. 7˜9, the oil injection block 21 has at least two or more joint springs 52 circumferentially mounted on a peripheral surface of an insertion portion 51 by means of set screws 53 or equivalent. The insertion portion 51 is a lower portion of the oil injection block 21.

The joint springs 52 are configured in such a manner that the insertion portion 51 assumes an outer diameter slightly greater than an inner diameter of the screw thread 50 when the joint springs 52 are uncompressed. When the insertion portion 51 is inserted into the screw thread 50, then the joint springs 52 are thereby compressed. In this state, the insertion portion 51 is jointed to an inner surface of the screw thread 50 by virtue of the spring forces of the joint springs 52.

In addition, a piece of packing 55 is mounted on the underside of a flange portion 54 by means of an adhesive or equivalent. The flange portion 54 is located at an upper end portion of the insertion portion 51. The packing 55 is attached with pressure to a cap-mounting seal surface 56 of the engine body, and the oil injection block 21 is thereby sealed to the engine body so as not to leak the cleaning oil.

Further, the oil injection block 21 has an injection-adapted connection hole 57 extending through a central portion thereof. A screw thread 58 is provided at an upper end portion of the connection hole 57. An injection pipe 11 is threadingly engaged with the screw thread 58 so as to pour the cleaning oil into the connection hole 57 from the cleaning machine 2.

Thus, it is only necessary that the oil injection block 21 is inserted with pressure into the oil injection hole 20 after removal of an oil injection cap from the hole 20, thereby connecting cleaning routes together. As a result, cleaning work can be practiced in a very short time. In addition, cleaning work at reduced cost is achievable because there is no need for replacing a component due to a size mismatch between the component and the cap-mounting screw thread 50.

As previously described, although the conventional static cleaning process can only partially wash the engine, the dynamic cleaning process according to the present invention provides a cleaning oil flow that keeps pace with a running state of the engine, thereby making it possible to wash off stains during engine operation. In addition, since the temperature of the cleaning oil lies in the rang of some 100 to 70° C. during engine operation, such a high temperature enhances the cleaning effectiveness of the oil. As a result, more efficient cleaning is achievable.

Accordingly, although the conventional static cleaning process requires cleaning for each six to twelve months, in the dynamic cleaning process according to the present invention, cleaning is required only for each nine to twenty four months because the effect of the dynamic cleaning process is sustained for a period of time as much as 1.5 to 2.0 times greater than the static cleaning process. As a result, economical and highly reliable cleaning is realized, in which the absence of incompletely cleaned areas reduces a likelihood of the occurrence of unexpected engine failures during travelling of a vehicle.

Further, cleaning work at reduced cost can be executed in a short time because the oil injection block 21 is pressed fit in the oil injection hole 20 at one-touch control so as to establish an injection route.

What is claimed is:

1. A method for cleaning a lubrication system of an automobile engine for gasoline-powered and diesel-powered vehicles, comprising the steps of: supplying cleaning oil stored in a solvent tank of a cleaning machine to an upper portion of an engine chamber through an oil injection hole of the engine by means of a discharge pump, at which time, the engine is running, and such injected cleaning oil is thereby sprinkled over the entire inner surface of the engine chamber by means of a camshaft, a connecting rod, a crankshaft, and a valve lifter, all of which are rotating, the cleaning oil being thereafter caused to stream down into an oil pan; permitting the cleaning oil reserved in the oil pan to flow into a lower lubrication passage through a strainer by means of an engine oil pump; then supplying the cleaning oil to an upper lubrication passage through an injection passageway of an oil filter block, the oil filter block being joined to an oil filter hole; permitting the cleaning oil to be again splashed over the entire inner surface of the engine chamber by means of the revolving camshaft, connecting rod, crankshaft, and valve lifter, the cleaning oil streaming down therefrom being stored in the oil pan; permitting the cleaning oil to be drawn from the oil pan into the cleaning machine through a drainpipe by means of a drain pump in the cleaning machine, a drain hole of the oil pan being connected to the drain pump through the drainpipe; discharging the cleaning oil into the solvent tank through a filter, thereby forming a circulating path, in which a connection pipe, which is joined to a connection passage through the injection passageway of the oil filter block, is branched into two branch pipes along two directions, one of which branch pipes is connected to a source of air through a check valve, the other branch pipe having a pressure meter mounted thereon, the other branch pipe being communicated to an injection pipe through a check valve, the cleaning oil flowing into the other branch pipe being blocked from flowing through the other branch pipe by means of the check valves, at which time, the pressure meter is possible to detect a loss of pressure inside lubrication system piping, and further to check how effectively cleaning is attained, and when pressure of the cleaning oil inside the connection pipe drops below discharge pressure of a supply pump, then the check valve is opened, and additional cleaning oil can be supplied to the upper lubrication passage by means of the supply pump, thereby forming a circulating system; stopping the engine when a cleaning process in which the engine is run for some 10 to 60 minutes in the above-described state is completed; and, then supplying air from the source of air, thereby air-purging the cleaning oil that is adhered to the circulating path inside the engine.

2. A method for cleaning a lubrication system of an automobile engine as defined in claim 1, wherein the cleaning oil reserved in the solvent tank in the cleaning machine is supplied to the upper lubrication passage through the oil filter hole, instead of being supplied thereto through the oil injection hole of the engine by means of the discharge pump.

3. A cleaning jig, i.e., oil injection block for use in a method for cleaning a lubrication system of an automobile engine, comprising: at least two or more joint springs circumferentially mounted on a peripheral surface of an insertion portion by means of set screws, the insertion portion being part of the oil injection block, the joint springs being configured in such a manner that the insertion portion assumes an outer diameter slightly greater than an inner diameter of a cap-mounting screw thread when the joint springs are uncompressed, but when the insertion portion is inserted into the screw thread, then the joint springs are thereby compressed, and as such, the insertion portion is jointed to an inner surface of the screw thread by virtue of spring forces of the joint springs; a piece of packing mounted on the underside of a flange portion by means of an adhesive, the flange portion being located at an upper end portion of the insertion portion, the packing being attached with pressure to a cap-mounting seal surface of an engine body, whereby the oil injection block is sealed to the engine body so as no to leak cleaning oil; and, an injection-adapted connection hole extending through a central portion of the oil injection block, an injection pipe being threadingly engaged with the connection hole so as to pour the cleaning oil into the connection hole from a cleaning machine.
